(19) United States
(12) Patent Application Publication
(10) Pub. No.: US 2016/0082978 A1
(43) Pub. Date: Mar. 24, 2016

(54) DRIVING ASSISTANCE APPARATUS AND DRIVING ASSISTANCE METHOD

(71) Applicants: Takashi OZAKI, Miyoshi-shi (JP); Shoichi SHONO, Miyoshi-shi (JP)

(72) Inventors: Takashi OZAKI, Miyoshi-shi (JP); Shoichi SHONO, Miyoshi-shi (JP)

(21) Appl. No.: 14/785,437

(22) PCT Filed: Apr. 16, 2014
(86) PCT No.: PCT/IB2014/000634

§ 371 Date: Oct. 19, 2015

(30) Foreign Application Priority Data
Apr. 18, 2013 (JP) 2013-087709

(51) Int. Cl. B60W 50/14; G01C 21/34

(52) U.S. Cl. CPC B60W 50/14; G01C 21/34; B60W 2550/10; B60W 2050/143; B60W 2050/146

(57) ABSTRACT

A driving assistance apparatus includes: a surrounding object detection device configured to detect an object in the surroundings of a vehicle; detected object classification unit configured to classify the object detected by the surrounding object detection device to predetermined types; traveling risk level determination unit configured to determine the traveling risk level of each road section as an index indicating the degree of the risk upon traveling in each road section based on the predetermined types of the objects classified by the detected object classification unit; and a traveling risk level recording unit configured to record the traveling risk level of the each road section determined by the traveling risk level determination unit.

### BACKGROUND OF THE INVENTION

1. Field of the Invention

The present invention relates to a driving assistance technology for a vehicle.

2. Description of Related Art

Generally, a vehicle driver recognizes a risky place on the road based on information about his or her previous driving experience as well as the condition of a road on which he or she is driving a vehicle presently. However, there is a difference in vehicle driver's experience level between one driver and another and thus, a vehicle driver having a short driving experience sometimes cannot recognize the risky place on the road because he or she has not sufficient information about the driving experience. In addition, although even a vehicle driver having a long driving experience can recognize the risky place on the road in a section where he or she frequently travels from his or her previous driving experience, he or she sometimes cannot recognize the risky place on the road about a section where he or she travels not so often.

Therefore, conventionally, there has been disclosed a technology which collects risk information concerning risky places on the road and supplies a vehicle driver with such information to assist his or her driving (e.g., Japanese Patent No. 3848554).

Japanese Patent No. 3848554 has disclosed a technology for determining the type of a risk such as “sudden braking”, “sudden acceleration”, “driver's state of tension”, “excited condition” based on outputs from a steering angle sensor, a vehicle velocity sensor, and an inter-vehicle distance sensor mounted on a vehicle, and a pulse sensor, a sound collection microphone and the like, and reflecting the result on a map data to provide the vehicle driver with that information for performing the driving assistance.

### SUMMARY OF THE INVENTION

However, a vehicle driver cannot acquire actual information about the road condition such as information that the road width is small and traffic amount of bicycles is large based on nothing but the risk information provided by various sensors arranged on a vehicle. Further, only from so-called “near-miss” information provided by a biological sensor such as a pulse sensor, the driver cannot acquire risk information which he or she has not noticed, for example, a motorbike located at a blind spot with respect to a vehicle, bicycle and the like. Thus, the driver cannot obtain sufficient risk information, so that no efficient driving assistance for the driver can be performed.

If the risk information is collected using various sensors arranged on a vehicle or a pulse sensor or the like which a driver wears, it comes that the system and the control are in a large scale thereby possibly generating time constraint or cost constraint for the development thereof.

Accordingly, the present invention provides a driving assistance apparatus and a driving assistance method capable of collecting risk information when a vehicle travels on a road more finely and determining and recording the degree of the risk upon traveling in a form corresponding to an actual state of the road.

The driving assistance apparatus according to a first aspect of the present invention includes: a surrounding object detection device configured to detect an object in the surroundings of a vehicle; a detected object classification unit configured to classify the object detected by the surrounding object detection device to predetermined types; a traveling risk level determination unit configured to determine the traveling risk level of each road section as an index indicating the degree of the risk upon traveling in the each road section based on the predetermined types of the objects classified by the detected object classification unit; and a traveling risk level recording unit configured to record the traveling risk level of the each road section determined by the traveling risk level determination unit.

In the above-described aspect, the detected object classification unit may classify the object to a moving object or a fixed object. In the above-described configuration, the detected object classification unit may, if the object is a movable object, classify the object to any one of a vehicle, a motorbike, a bicycle or people.

In the above-described aspect, the traveling risk level determination unit may determine the traveling risk level of the each road section based on a relative distance between the vehicle and the object and/or a relative velocity between the vehicle (100) and the object.

In the above-described aspect, the driving assistance apparatus may further include a road width calculation unit configured to calculate the road width of the each road section and the detected objet classification unit may classify the object to a movable object or a fixed object. The road width calculation unit may, of the objects detected by the surrounding object detection device when the vehicle travels in each road section, calculate the road width of the each road section based on each object which is classified to a fixed object by the detected object classification unit; and the traveling risk level determination unit may determine the traveling risk level of the each road section based on the road width of the each road section calculated by the road width calculation unit.

In the above-described aspect, the traveling risk level recording unit may, if the traveling risk level of a road section corresponding to the traveling risk level determined by the traveling risk level determination unit has been already recorded, record an average value obtained by averaging the traveling risk level determined by the traveling risk level determination unit and the already recorded traveling risk level as a new traveling risk level of the given road section.

In the above-described aspect, the driving assistance apparatus may further include a communication unit which communicates with a traveling risk level information center for collecting the traveling risk level of the each road section from a plurality of probe vehicles, and the traveling risk level recording unit may acquire the traveling risk level of the each road section from the traveling risk level information center via the communication unit and record the acquired traveling risk level of the each road section.

In the above-described configuration, the traveling risk level recording unit may, if the traveling risk level of a road section corresponding to the traveling risk level acquired from the traveling risk level information center has been already recorded, record an average value obtained by averaging the traveling risk level acquired from the traveling risk level information center and the already recorded traveling risk level as a new traveling risk level of the given road section.

In the above-described aspect, when the vehicle travels in a road section, the traveling risk level of the road section recorded by the traveling risk level recording unit may be reported to a driver.

In the above-described aspect, the driving assistance apparatus may further includes a route guidance unit which performs route guidance for a driver from a departure point specified by the driver to a destination, and the traveling risk level of the each road section which has been recorded by the traveling risk level recording unit as a traveling risk level of each road section contained in a route through which the vehicle is to be guided by the route guidance unit is reported to the driver.

Further, the driving assistance method according to a second aspect of the present invention includes: detecting an object in the surroundings of a vehicle; classifying the detected object to predetermined types; determining the traveling risk level of the each road section as an index indicating a degree of the risk upon traveling in a road section based on the predetermined types of the classified objects; and recording the determined traveling risk level of the each road section.

The first and second aspects of the present invention provide a driving assistance apparatus capable of collecting risk information when a vehicle travels on a road more finely and determining and recording the degree of risk upon traveling in a form corresponding to an actual state of the road.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall schematic diagram illustrating a driving assistance apparatus 1 according to a first embodiment;

FIG. 2 is a flow chart for determination and recording of a traveling risk level which is performed by the driving assistance apparatus 1 (ECU 21) according to the first embodiment;

FIG. 3 is a table for explaining a specific traveling risk level determination method to be executed by the driving assistance apparatus 1 (ECU 21) according to the first embodiment;

FIG. 4 is an overall schematic diagram illustrating a driving assistance apparatus 2 according to a second embodiment; and

FIG. 5 is an overall schematic diagram illustrating a driving assistance apparatus 3 according to a third embodiment.

### DETAILED DESCRIPTION OF EMBODIMENTS

Hereinafter, the embodiments for carrying out the present invention will be described with reference to the accompanied drawings below.

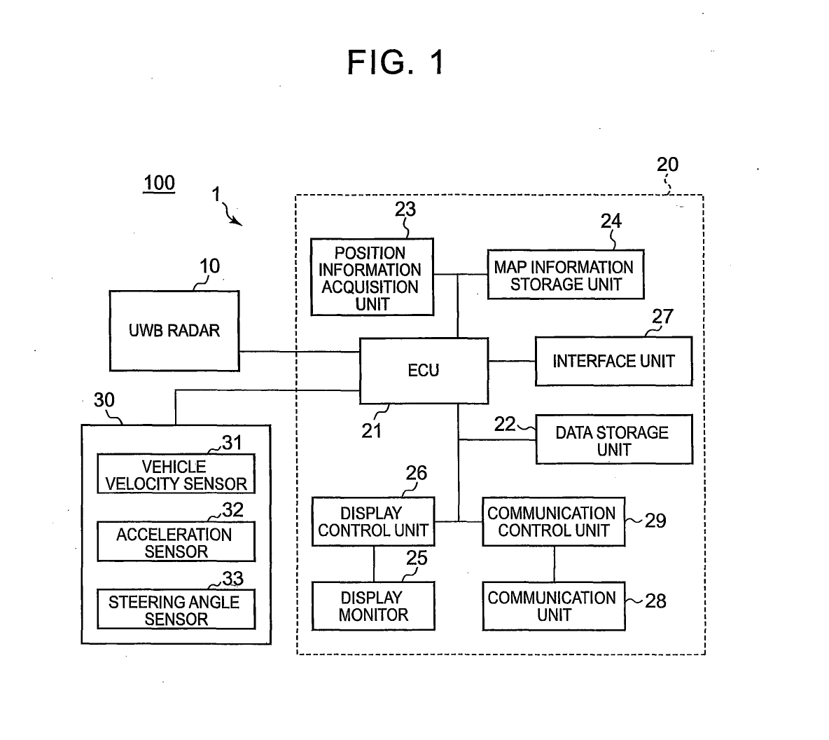

First, the first embodiment will be described. FIG. 1 is an overall schematic diagram illustrating the driving assistance apparatus 1 according to the present embodiment.

The driving assistance apparatus 1 is mounted on a vehicle 100 and to perform a driving assistance for a driver, determines the traveling risk level as an index about the risk level when the driver travels in each road section and records the traveling risk level of each road section. Further, as described below, the same driving assistance apparatus performs a display for encouraging attention on a display monitor 25 based on the recorded traveling risk level of each road section to assist a safety driving and the like of the driver.

The vehicle 100 is provided with an engine (not shown) and its drive wheels (not shown) are driven by the engine via a transmission (not shown) and the like so that the vehicle travels. In the meantime, the vehicle 100 may be any type of vehicle such as a hybrid vehicle, electric vehicle, a fuel cell vehicle and the like.

The driving assistance apparatus 1 includes a UWB (ultra-wide band) radar (surrounding object detection device) 10, an ECU (detected object classification unit, traveling risk level determination unit, traveling risk level recording unit, road width calculation unit) 21, a data storage unit 22, a position information acquisition unit 23, a map information storage unit 24, a display monitor 25, a display control unit 26 and the like.

The UWB radar 10 detects an object in the surroundings of the vehicle 100 corresponding to traveling of the vehicle 100. In the meantime, the object refers to general objects which exist in space with a specific shape regardless of whether it is a living object or non-living object. For example, on the road, a walking pedestrian as well as an automobile and a guard rail are included. Hereinafter, the object will be used with the same meaning in the specification, claims and the like. The UWB radar 10 is a surrounding object detection unit having a resolution capable of classifying a detected object (hereinafter referred to as detected object) to automobile, motorbike, bicycle and people. In the meantime, although in the present embodiment, the UWB radar (radio wave radar) 10 which excels in that it is difficult to be affected by the weather, night and the like is used, any surrounding object detection unit may be used such as a camera, laser radar as long as it has the aforementioned resolution.

The UWB radar 10 transmits a short pulse wave of several nanoseconds and receives its reflected wave to detect an object in the surroundings. Further, the UWB radar 10 has a resolution of 10 cm or less by using the short pulse signal of several nanoseconds and for example, it can detect a difference between a motorbike and a bicycle. Based on a time difference from transmission to receiving of the short pulse, it can detect a relative distance between the vehicle 100 and a detected object. Further, it can detect a relative velocity between the vehicle 100 and the detected object using Doppler effect. The UWB radar 10 outputs data (signal) including reflected wave received from a detected object, a relative distance to the detected object, a relative velocity and the like to the ECU 21 which will be described below.

Because when a vehicle 100 travels, the UWB radar 10 detects surrounding objects which approach the vehicle 100 from all directions, it is preferable to arrange a plurality of the radars on the vehicle 100, for example, four units are mounted on four corners of the vehicle 100. More specifically, by providing two units in both ends of a front bumper and two units in both ends of a rear bumper, objects existing in all directions of 360° as seen in plan view of the vehicle 100 can be detected.

The ECU 21 is an information processing terminal including a CPU, a RAM, a ROM, an I/O unit and the like, and the CPU performs various kinds of processing according to programs stored in the ROM.

Data (signal) including reflected wave received from a detected object, a relative distance to the detected object, a relative velocity and the like is input to the ECU 21 from the UWB radar 10. Further, the ECU 21 transmits an instruction to the position information acquisition unit 23 and acquires a position (latitude, longitude) of the vehicle 100 when the above-described data is input from the UWB radar 10. Further, the ECU 21 acquires map information by transmitting an instruction to the map information storage unit 24 and introduces information regarding a road section corresponding to the position of the vehicle 100 and a distance of the road section. As described below, the ECU 21 classifies the detected object based on the aforementioned data input from the UWB radar 20, a road section corresponding to the data and a distance of that road section and determines the traveling risk level of each road section based on the classification. The determined traveling risk level of each road section is output to the data storage unit 22 and recorded therein. In the meantime, the road section is defined, for example, between a node (intersection) and another node (intersection) or the like and predetermined as a unit which is linked with the traveling risk level.

To perform driving assistance by encouraging a driver of the vehicle 100 to pay attention by displaying the traveling risk level of a road section where the vehicle 100 is traveling on the display monitor 25, as described below, the ECU 21 acquires the traveling risk level of the road section where the vehicle 100 is traveling from the data storage unit 22 and outputs to the display control unit 26. Further, as described below, to indicate the traveling risk level of each road section on a route guide indication on the display monitor 25 by means of a navigation unit (route guide unit) 20 at the same time, the traveling risk level of each road section on the route guide indication is acquired from the data storage unit 22 and output to the display control unit 26. In the meantime, the ECU 21 is included in the navigation unit 20 of the vehicle 100 and performs processing and the like for route search and route guide. The navigation unit 20 performs route guidance for a driver from a departure point specified by the driver to a destination.

Further, the ECU 21 can receive an information signal from a vehicle sensor 30 mounted on the vehicle 100. The information signal such as vehicle velocity, acceleration and steering angle of the vehicle 100 is input from a vehicle velocity sensor 31, an acceleration sensor 32, a steering angle sensor 33 and the like contained in the vehicle sensor 30.

The data storage unit 22 is a nonvolatile storage unit which records the traveling risk level of each road section determined by the ECU 21. In the meantime, the data storage unit 22 is contained in the navigation unit 20 of the vehicle 100 and stores data such as road traffic information received from a road traffic information center (not shown) via a communication unit 28.

The position information acquisition unit 23 is a GPS (global position system) receiver. It receives a signal from several (e.g., four) GPS satellites in the space, calculates a position (latitude, longitude) of the vehicle 100 and outputs to the ECU 21.

The map information storage unit 24 is a nonvolatile storage unit which stores map information. In the meantime, the map information includes linked position information, linked road type (classification of expressway, local road, urban street, etc.) information, node position information, node type information, node-link connection information and the like.

The display monitor 25 has a liquid crystal display or the like, and displays video image corresponding to a video signal concerning the traveling risk level of each road section which is input from the ECU 21 via the display control unit 26. In the meantime, the display monitor 25 is contained in the navigation unit 20 of the vehicle 100 and displays route guidance from a departure point to a destination which is input from the ECU 21 via the display control unit 26, for example. According to the present embodiment, as described below, the traveling risk level of a road section on which the vehicle 100 is currently traveling and the like are displayed on the display monitor 25 to perform driving assistance for a driver through encouraging attention or the like. Further, as described below, the traveling risk level of each road section is displayed on the road section of the route guidance representation made by the navigation unit 20 displayed on the display monitor 25 at the same time to perform driving assistance. In the meantime, acoustic driving assistance such as encouraging attention through a speaker (not show) may be also performed together with display of the traveling risk level on the display monitor 25. In this case, the sound signal for driving assistance is generated by the ECU 21 and input to the speaker.

The display control unit 26 generates a video signal for displaying the traveling risk level to be input from the ECU 21 and outputs to the display monitor 25. In the meantime, the display control unit 26 is contained in the navigation unit 20 of the vehicle 100 and generates a video signal for displaying the route guidance information and the like to be input from the ECU 21, for example, and outputs to the display monitor 25.

Next, determination and recording of the traveling risk level of each road section which is to be performed by the driving assistance apparatus 1 (ECU 21) of the present embodiment will be described.

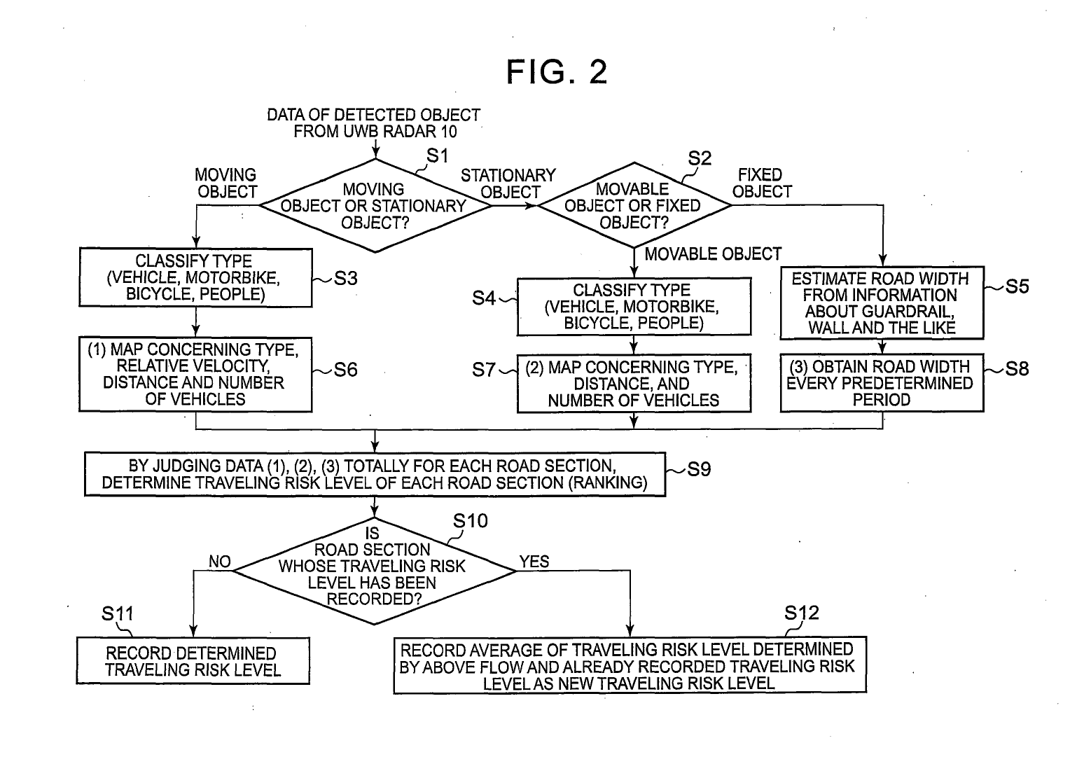

FIG. 2 is a flow chart for determination and recording of the traveling risk level to be performed by the driving assistance apparatus 1 (ECU 21) of the present embodiment. In the meantime, hereinafter, data (signal) concerning reflected wave, a relative distance to the detected object, and a relative velocity which is received from the detected object and is to be input from the UWB radar 10 to the ECU 21 is called detected object data. Further, the processing of the flow chart of FIG. 2 which will be described below is performed by executing a predetermined program stored in the ROM within the ECU 21 by means of the CPU in the ECU 21.

First, in step S1, whether the detected object is a moving object or a stationary object is determined. Based on signals concerning a relative velocity of the detected object in the detected object data input from the UWB radar 10, and a vehicle velocity, an acceleration and a steering angle of the vehicle 100 from the vehicle velocity sensor 31, the acceleration sensor 32 and the steering angle sensor 33, whether the detected object is stationary or moving is determined. In the meantime, the moving object means an object which is moving and the stationary object means an object which is stationary.

If it is determined that the detected object is stationary in step S1, the processing proceeds to step S2, in which whether the stationary object is a movable object or a fixed object is determined. In the meantime, the movable object means an object which can move, for example, a vehicle which is stopped. The fixed object means an object which is fixed, for example, a wall (building) or a guard rail. More specifically, because the reflected wave received from the detected object has a different characteristic between the moving object such as a vehicle, a motorbike, a bicycle, and people and the fixed object such as the wall, the guard rail, the determination is performed based on each characteristic. In the meantime, the characteristic of the reflected wave which is different between the moving object and the fixed object and received from the detected object is known preliminarily from experiments or the like.

If it is determined that the detected object is a moving object in step S1, the processing proceeds to step S3, in which the moving object is classified to the vehicle, motorbike, bicycle, and people. More specifically, because the reflected wave received from the detected object has a different characteristic depending on the vehicle, the motorbike, the bicycle, and people, the classification is performed based on each characteristic. In the meantime, the characteristic of the reflected wave which is different depending on the detected object such as the vehicle, the motorbike, the bicycle and people is known preliminarily from experiments or the like.

Likewise, if it is determined that the stationary object is a movable object in step S2, the processing proceeds to step S4, in which the movable object is classified to the vehicle, the motorbike, the bicycle and people.

If the moving object is classified to the vehicle, the motorbike, the bicycle or people in step S3, mapping for determining the traveling risk level is performed based on the classification of the detected object, a relative distance to the detected object, a relative velocity and a number of objects (persons) in step S6. In the meantime, the traveling risk level is determined for each road section as described below and the number of objects (persons) is a number of objects (persons) which is detected by the vehicle 100 in each road section.

Likewise, if the movable object which is a stationary object is classified to the vehicle, the motorbike, the bicycle or people in step S4, mapping for determining the traveling risk level is performed based on the classification of the detected object, a relative distance between the vehicle 100 and the detected object and the number of objects (persons) in step S7. In the meantime, the traveling risk level is determined for each road section as described below and the number of objects (persons) is a number of objects (persons) which is detected by the vehicle 100 in each road section.

Here, mapping of step S6, S7 will be described specifically.

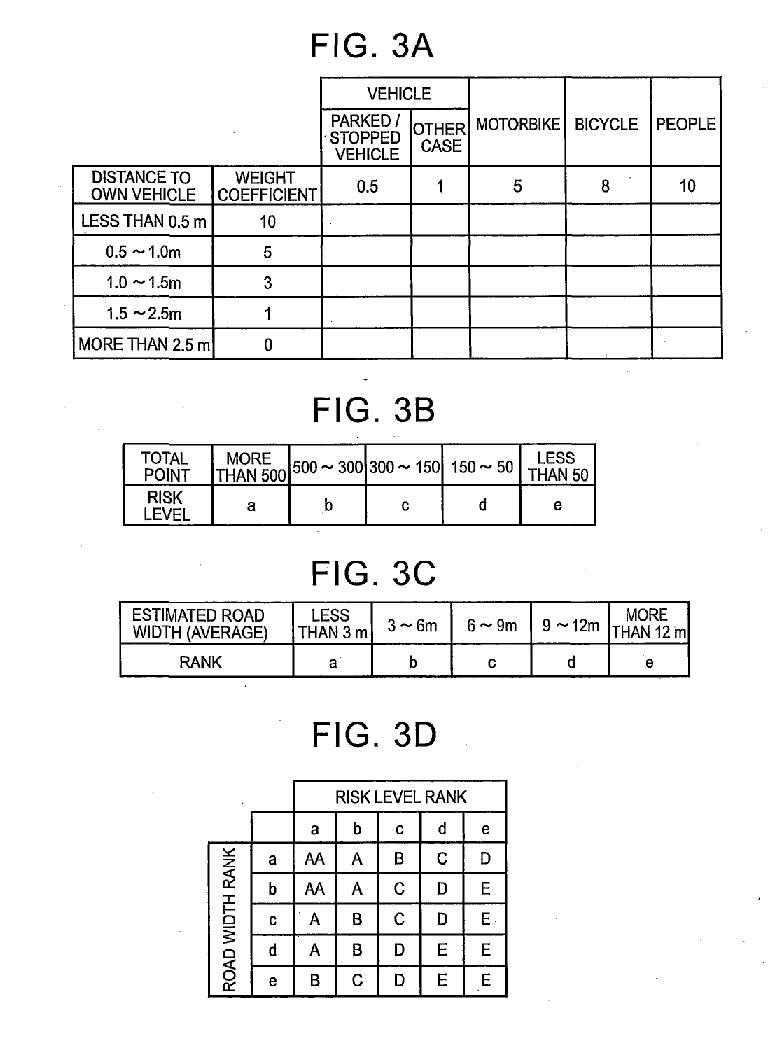

FIG. 3A is a map for determining the traveling risk level as described above and more specifically, an appearance frequency count map for the movable objects in each road section. In the meantime, in the present embodiment, the maps of steps S6, S7 is expressed as a single map. Because the moving object is a movable object which is moving now, in the present embodiment, just the movable object will be used without differentiating between the moving object and the movable object. Regarding the movable object of the detected objects which are detected by the UWB radar 10 in each road section, count is performed in any mass of the Table and then, the traveling risk level in step S9 described below is determined based on total points of the entire table in which the count of each mass is multiplied with a weight coefficient corresponding to each mass.

Referring to FIG. 3A, basically, respective columns of the table are classified to types of the movable objects described above, such as the vehicle, the motorbike, the bicycle and people. Further, the vehicle is further classified depending on whether it is parked/stopped (stationary) or moving. In the meantime, in the present embodiment, because the motorbike and the bicycle are seldom parked or stopped on the road and people provides no difference in risk level between when people is moving and when people is stationary because his or her moving speed is low, no discrimination depending on whether or not each of those objects is moving is performed about those objects for simplification. For each column, the weight coefficient has been determined which serves as a basis for calculating the total points of the entire table to determine the traveling risk level. A higher weight coefficient means a higher traveling risk level. The weight coefficient is 0.5 for a vehicle which is parked or stopped, 1 for a moving vehicle, 5 for a motorbike, 8 for a bicycle and 10 for people. Compared to the vehicle, the weight coefficient of the motorbike, bicycle, and people is set higher because they enter a blind spot easily.

Next, respective rows of the table are classified depending on the relative distance between the vehicle 100 and the movable object. In the meantime, the relative distance between the vehicle 100 and the movable object means a relative distance when the movable object approaches most. More specifically, the relative distance is classified to five levels, i.e., less than 0.5 m, 0.5 m through 1.0 m, 1.0 m through 1.5 m, 1.5 m through 2.5 m, and more than 2.5 m. This is the same as the columns as described above in that the weight coefficient which serves as a basis for calculating the total points of the overall table for determining the traveling risk level of each row and in that a higher weight coefficient provides a higher traveling risk level. Because the risk level increases as the relative distance between the vehicle 100 and the movable object decreases, the weight coefficient is set to 10, 5, 3, 1, 0 from less than 0.5 m to more than 2.5 m.

In the meantime, although in the present embodiment, as described above, the mapping is performed based on the relative distance and the relative velocity (whether or not the movable object is moving) between the vehicle 100 and the movable object to determine the traveling risk level of each road section described below, the traveling risk level of each road section may be determined based on the relative distance or the relative velocity between the vehicle 100 and the movable object. For example, the mapping may be performed by considering the relative velocity without considering the risk level due to the relative distance for simplification, and the traveling risk level of each road section may be determined. Alternatively, the above-described mapping may be performed by considering the relative distance without considering the relative velocity to determine the traveling risk level of each road section.

The number of objects (number of persons) detected in each road section is counted in each mass of the table and a point of each mass is obtained by multiplying the number of the objects (number of persons) with the weight coefficient of the row and the column. For example, if two motorbikes which comes close to 0.5 m or less in each road section are detected, the point of the mass which is an intersection of “0.5 m or less” and “motorbike” turns to 100 by multiplying the number 2 with a weight coefficient 10 of “0.5 m or less” and a weight coefficient 5 of “motorbike”. Such an operation is performed for each mass and for each road section, and the total point is calculated by summing the points of the entire table (all the masses of the table) for each road section.

Finally, by dividing the total point by a calculated distance of each road section, the total point per a unit distance is obtained to enable comparison among the respective road sections. In the meantime, hereinafter, “total point per unit time” is called jut “total point”.

Returning to the flow chart, if it is determined that the stationary object is a fixed object in step S2, the processing proceeds to step S5, in which of the fixed objects, a road width is estimated from data concerning the guard rail or the wall. Because apparently, the traveling risk level increases as the road width decreases, the traveling risk level based on the road width is determined in step S9 described below based on the estimated road width. Because the UWB radars 10 are provided on both ends of the front bumper as described above, they can receive the reflected wave from both ends of the road, the wall or the guard rail and the relative distance can be calculated, and then, the road width is estimated based on these. Because the wall and the guard rail have a flat form, it is possible to determine the risk level from the fixed objects using the characteristic of the reflected wave from the wall or the guard rail. Such an estimation of the road width is performed every predetermined distance with a moving of the vehicle 100.

Then, the processing proceeds to step S8, in which an average of the road width estimated every predetermined distance for each road section is calculated and the calculated value is picked up as an estimated road width of each road section.

By judging the total point of the map of FIG. 3A corresponding to the above-described steps S6, S7 and the estimated road width calculated in step S8, the traveling risk level of each road section is determined in step S9.

More specifically, the traveling risk level of the movable object is determined based on the total point calculated by the map of FIG. 3A corresponding to steps S6, S7.

FIG. 3B shows ranks of the traveling risk level of the movable object. The traveling risk level is classified to five levels, i.e., “a” though “e”, and it is indicated that the “a” has the highest risk level. If the total point calculated from the map of FIG. 3A described above is more than 500, the traveling risk level is “a”. If the above total point is 300 through 500, the traveling risk level is “b”. If the above total point is 150 through 300, the traveling risk level is “c”. If the above total point is 50 through 150, the traveling risk level is “d”. If the above total point is less than 50, the traveling risk level is “e”. In this way, the traveling risk level due to the movable object of each road section is determined based on the above total point.

Next, the traveling risk level due to the road width is determined based on the estimated road width calculated in step S8.

FIG. 3C shows ranks about the traveling risk level due to the road width. Like ranking of the traveling risk level due to the movable object, the traveling risk level is classified to five levels, i.e., “a” through “e” and it is indicated that “a” has the highest risk level. If the estimated road width is less than 3 ms, the traveling risk level is “a”. If the estimated road width is 3 through 6 m, the traveling risk level is “b”. If the estimated road width is 6 through 9 m, the traveling risk level is “c”. If the estimated road width is 9 through 12 m, the traveling risk level is “d”. If the estimated road width is more than 12 m, the traveling risk level is “e”. In this way, the traveling risk level due to the estimated road width of each road section is determined based on the estimated road width.

Next, a total determination is made by the traveling risk level due to the movable object and the traveling risk level due to the estimated road width which have been determined as described above, so as to determine the traveling risk level of each road section.

FIG. 3D shows a table for determining the traveling risk level of each road section. Total risk level of each road section is determined from the traveling risk level (rank) due to the movable object based on FIG. 3B and the traveling risk level (rank) due to the estimated road width based on FIG. 3C. The total traveling risk level is classified to six levels, i.e., “AA” through “E” and “AA” has the highest traveling risk level while “E” has the lowest risk level. In a certain road section, for example, if the above-described total point is 350 so that the rank of the traveling risk level due to the movable object is determined to be “b” based on FIG. 3B and the estimated road width is 7 m so that the rank of the traveling risk level due to the estimated road width is determined to be “c” based on FIG. 3C, the total traveling risk level in the given road section is determined to be “B” based on FIG. 3D.

If the total risk level is determined in step S9, the processing proceeds to step S10, in which whether or not the traveling risk level has been already recorded concerning the road section whose total traveling risk level has been determined is determined.

If no traveling risk level has been recorded concerning the given road section in step S10, the processing proceeds to step S11, in which the total traveling risk level determined in step S9 is recorded in the data storage unit 22. Further, it is preferable to record the traveling risk level due to the movable object, the traveling risk level due to the estimated road width and at the same time, the total point and the estimated road width which serve as a premise therefor

If the traveling risk level has been already recorded concerning the road section in step S10, the processing proceeds to step S12, in which an average of the total traveling risk level determined in step S9 and the already recorded traveling risk level is recorded as a new traveling risk level of the given road section. More specifically, for example, if the recorded total traveling risk level is “B” and the total traveling risk level determined in step S9 is “D”, simply the new total risk level may be considered to be “C”. Further, from viewpoints of increasing accuracy, averaging may be performed based on the total point and the estimated road width which serve as a premise for the traveling risk level due to the movable object and the traveling risk level due to the estimated road width corresponding to the recorded total traveling risk level and additionally, the total point and the estimated road width which serve as a premise for the traveling risk level due to the movable object and the traveling risk level due to the estimated road width which have been determined in step S9. Further, concerning a given road section, if the vehicle traveled on that road section plural times before, it is permissible to perform weighted average by multiplying an already recorded traveling risk level with a weight corresponding to the previous traveling time.

Next, an example of driving assistance using the traveling risk level of each road section recorded in the data storage unit 22 by means of the ECU 21 will be described.

When the vehicle 100 is traveling in a road section, a driver is encouraged to pay attention by reporting the traveling risk level of the given road section recorded in the data storage unit 22 to the driver. More specifically, the ECU 21 acquires the traveling risk level of the given road section recorded in the data storage unit 22 and outputs a video signal adapted to display the traveling risk level on the display monitor 25 via the display control unit 26. As a result, when the vehicle is traveling in the road section whose traveling risk level has been recorded in the data storage unit 22, the driver can drive the vehicle recognizing the traveling risk level of the given road section and thereby the driver can avoid the risk securely. In the meantime, reporting of the traveling risk level of the given road section to the driver may be performed through sound when the ECU 21 outputs an acoustic signal to a speaker (not shown).

Next, if the navigation unit 20 is performing route guidance from a departure point specified by the driver to a destination, the traveling risk level of each road section contained in the route through which the vehicle is to be guided by the navigation unit 20 is reported to the driver. More specifically, when the navigation unit 20 displays the guidance route from the departure point to the destination on the display monitor 25, the ECU 21 acquires the traveling risk level of each road section contained in the guidance route recorded in the data storage unit 22 and displays on the display monitor 25 at the same time. As a result, the traveling risk level of the guidance route can be recognized beforehand by the driver so that the driver can avoid the risk securely.

Next, an operation of the driving assistance apparatus 1 of the present embodiment will be described.

Because the driving assistance apparatus 1 of the present embodiment detects surrounding objects in all directions using the UWB radar 10, it can detect any object which is positioned in the blind spot with respect to the driver so that usually it cannot be recognized. Thus, because the traveling risk level is determined by considering also risks (potential risks) which usually the driver does not notice, the traveling risk level of each road section according to the present embodiment comes to correspond to the state of the road more accurately. Further, by performing the driving assistance by reporting the traveling risk level to the driver using the traveling risk level which corresponds to the actual state of the road, the driver can avoid the risk more securely.

Further, the driving assistance apparatus 1 of the present embodiment performs a predetermined classification about an object detected by the UWB radar 10 and determines the traveling risk level of each road section based on the classification of the detected object. Objects which approach the vehicle 100 on the road are not uniform so that the risk level varies depending on the type of the object. Thus, the traveling risk level which has been determined based on the classification of the detected object comes to correspond to the actual state of the road. Further, by performing the driving assistance by reporting the traveling risk level to the driver using the traveling risk level which corresponds to the actual state of the road, the driver can avoid the risk securely.

Further, because the driving assistance apparatus 1 of the present embodiment classifies the detected object to specifically, a vehicle, a motorbike, a bicycle or people which affects the traveling risk level highly, the determination of the traveling risk level based on that classification comes to correspond to the actual state of the road more accurately. By performing the driving assistance by reporting the traveling risk level to the driver using the traveling risk level which corresponds to the actual state of the road more accurately, the driver can avoid the risk more securely.

Further, the driving assistance apparatus 1 of the present embodiment determines the traveling risk level of each road section based on the relative distance between the vehicle 100 and the movable object and/or the relative velocity. As a result, the traveling risk level of each road section is determined based on a specific state of the road, that is, a specific proximity relationship to the movable object, so that such traveling risk level comes to correspond to the actual state of the road more accurately. Further, by performing the driving assistance by reporting the traveling risk level to the driver using the traveling risk level which corresponds to the actual state of the road more accurately, the driver can avoid any risk more securely.

Further, the driving assistance apparatus 1 of the present embodiment estimates the road width from the guardrail, the wall or the like detected by the UWB radar 10 as well as the movable objects and based thereon, determines the traveling risk level of each road section. As a result, it comes that the traveling risk level can be determined by considering the road width also, and consequently, the accuracy of the traveling risk level increases so that the traveling risk level comes to correspond to the actual state of the road more accurately. Further, by performing the driving assistance by reporting the traveling risk level to the driver using the traveling risk level which corresponds to the actual state of the road more accurately, the driver can avoid the risk more securely.

If the traveling risk level of a road section which corresponds to the traveling risk level determined by the ECU 21 has been already recorded in step S9 of the flow chart of FIG. 2, the driving assistance apparatus 1 of the present embodiment records an average value obtained by averaging the traveling risk level determined in step S9 and the already recorded traveling risk level as a new traveling risk level of the given road section. As a result, as the vehicle travels in the given road section, the accuracy of the traveling risk level of the given road section can be intensified, so that the traveling risk level comes to correspond to the actual state of the road more accurately. Further, by performing the driving assistance by reporting the traveling risk level to the driver using the traveling risk level which corresponds to the actual state of the road more accurately, the driver can avoid the risk more securely.

When the vehicle 100 is traveling in a certain road section, the traveling risk level of the given road section recorded in the data storage unit 22 is reported to the driver. More specifically, the traveling risk level of the given road section is displayed on the display monitor 25. As a result, the driver can be encourage to pay attention by using the traveling risk level which corresponds to the road state determined by the driving assistance apparatus 1 of the present embodiment, so that the driver can avoid the risk accurately in response to the road state.

Further, the traveling risk level of each road section contained in a route through which the vehicle is guided by the navigation unit 20 is reported to the driver. More specifically, when a guidance indication is displayed on the display monitor 25 by the navigation unit 20, the traveling risk level of each road section contained in the guidance route is displayed at the same time. As a result, the traveling risk level of the guidance route can be recognized by the driver beforehand using the traveling risk level which corresponds to the road state determined by the driving assistance apparatus 1 of the present embodiment, so that the driver can avoid the risk more securely in response to the road state.

Next, a second embodiment will be described.

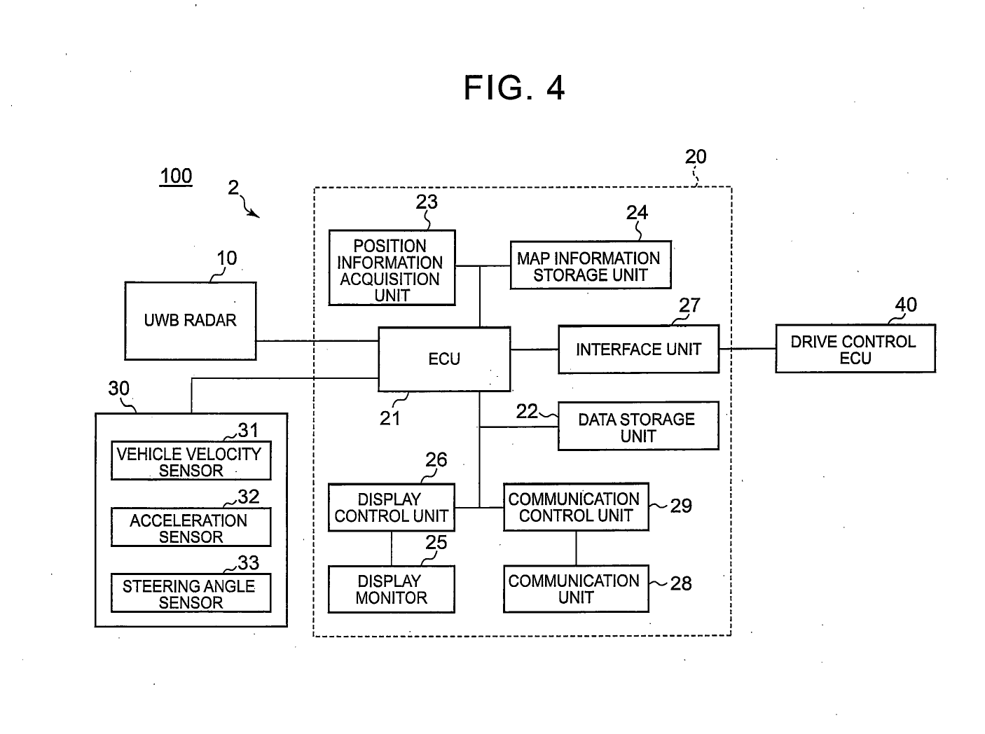

FIG. 4 is an overall schematic diagram illustrating the driving assistance apparatus 2 of the present embodiment.

The driving assistance apparatus 2 of the present embodiment is different from the first embodiment in that it instructs a drive control ECU 40 based on the traveling risk level of each road section which is determined by the ECU 21 and recorded in the data storage unit 22 to perform traveling control (neutral traveling inhibition control) described below. Hereinafter, with like reference numerals attached to the same components as the first embodiment, mainly only different portions will be described.

Like the first embodiment, the driving assistance apparatus 2 is mounted on the vehicle 100 and determines the traveling risk level of each road section as an index concerning the degree of risk upon traveling in each road section and records the traveling risk level of each road section to perform the driving assistance for the driver. Further, based on the recorded traveling risk level of each road section, it performs display or the like for encouraging attention on the display monitor 25 to perform the driving assistance for the driver. Further, in the present embodiment, as described below, it instructs the drive control ECU 40 based on the recorded traveling risk level of each road section to perform traveling control (neutral traveling inhibition control).

The vehicle 100 on which the driving assistance apparatus 2 is to be mounted is provided with an engine (not shown) and an automatic transmission (not shown) and its drive wheels are driven by the engine via the automatic transmission so that the vehicle travels. In the meantime, the vehicle 100 may be any vehicle, such as a hybrid vehicle, an electric vehicle, a fuel cell vehicle or the like.

The driving assistance apparatus 2 includes an interface unit 27, a drive control ECU 40 and the like.

The interface unit 27 is a portion which performs processing for the ECU 21 to perform I/O of signal (information) with other ECU and the like. The ECU 21 outputs instruction signal, information signal and the like to the drive control ECU 40 and the like via the interface unit 27, and information signal or the like from the drive control ECU 40 is input therein via the interface unit 27.

The drive control ECU 40 performs control or the like for changing the shift position of the automatic transmission (transmission stage, etc.). More specifically, it performs changing the shift position or the like based on information concerning engine rotational speed, accelerator operation amount, fuel injection amount and the like. Particularly, under a predetermined traveling condition, the drive control ECU 40 changes the shift position to neutral to drive the vehicle 100 in the neutral state. For example, on a mild slope or the like, the shift position is changed to the neutral state and with the engine idling (or remaining stopped), the vehicle 100 can perform inertial traveling thereby improving fuel consumption performance. In the meantime, traveling of the vehicle 100 with the shift position in the neutral state is hereinafter called neutral traveling. The drive control ECU 40 outputs information concerning the shift position or the like to the ECU 21 and an instruction from the ECU 21, for example, an instruction of inhibiting the neutral traveling described below is input thereto.

Like the first embodiment, the ECU 21 determines and records the traveling risk level of each road section. FIG. 2 is a flow chart for determination of the traveling risk level which is executed by the driving assistance apparatus 2 (ECU 21) of the present embodiment. Thus, a specific method for determination and recording of the traveling risk level of each road section is the same as the first embodiment and therefore, a detailed description thereof is omitted.

Further, based on the traveling risk level of each road section which is determined and recorded, the ECU 21 performs driving assistance by reporting the traveling risk level to the driver. Because the example of the driving assistance using the traveling risk level of each road section recorded in the data storage unit 22 is the same as the first embodiment, a detailed description thereof is also omitted.

In the present embodiment, based on the traveling risk level of each road section which is determined by the ECU 21 and recorded in the data storage unit 22, it instructs the drive control ECU 40 to perform a control of inhibiting the neutral traveling (hereinafter referred to as neutral traveling inhibition control). Hereinafter, the neutral traveling inhibition control based on the traveling risk level of each road section will be described.

When the vehicle 100 reaches an end point of the road section whose traveling risk level has been recorded, the ECU 21 determines whether or not the traveling risk level of a given road section is higher than a predetermined level. For example, whether or not the total traveling risk level described in the first embodiment is “B” or higher, i.e., “AA”, “A” or “B” is determined.

Here, if the traveling risk level of a given road section is lower than a predetermined level, for example, the total traveling risk level is “C”, the ECU 21 performs no processing.

If the traveling risk level of the given road section is higher than the predetermined level, for example, the total rank of the traveling risk level is “B”, the ECU 21 outputs an instruction of inhibiting the neutral traveling in the given road section to the drive control ECU 40. In the meantime, the drive control ECU 40 makes a control not to change the shift position of the automatic transmission to neutral in the given road section during traveling. In other words, the ECU 21 performs the neutral traveling inhibition control via the drive control ECU 40.

The neutral traveling is inertial traveling in a state in which a drive power transmission path between transmission mechanism constituted of an engine and an automatic transmission and drive wheels is shut down and therefore, a drive power from the drive wheels to the ground surface is zero, thereby possibly producing a problem in avoiding the risk. For example, in case of a front-wheel-drive vehicle, when steering the vehicle to avoid a collision with an oncoming vehicle which enters its own vehicle lane, the vehicle moves largely in the right-left direction compared to when a drive force is applied from the drive wheels to the road surface thereby possibly disabling the vehicle 100 from being controlled well. In case of a rear-wheel-drive vehicle, an amount by which the vehicle moves in the right-left direction is smaller compared to the case where the drive force is applied from the drive wheels to the road surface thereby sometimes disabling the vehicle from avoiding collision with the oncoming vehicle. In such a road section whose traveling risk level is somewhat high, the neutral traveling may sometimes be an obstacle to avoiding the risk securely. Thus, as described above, if the traveling risk level of a road section in which a vehicle travels is higher than a predetermined level, the driver can avoid the risk securely by inhibiting the neutral traveling.

When the vehicle 100 reaches the end point of the road section whose traveling risk level has been recorded, the ECU 21 determines whether or not the traveling risk level of a given road section is higher than a predetermined level. However, upon traveling on a guidance route provided by the navigation unit 20, the same determination may be performed before the traveling. For example, it is permissible to perform the same determination concerning each road section contained in the given guidance route and upon traveling in a road section whose traveling risk level has been determined to be higher than a predetermined level by the same determination, for the ECU 21 to output an instruction of inhibiting the neutral traveling to the drive control ECU 40. Further, the driving assistance apparatus 2 of the present embodiment exerts the same operation and effect as the first embodiment as well as the above-described operation and effect.

Next, a third embodiment will be described.

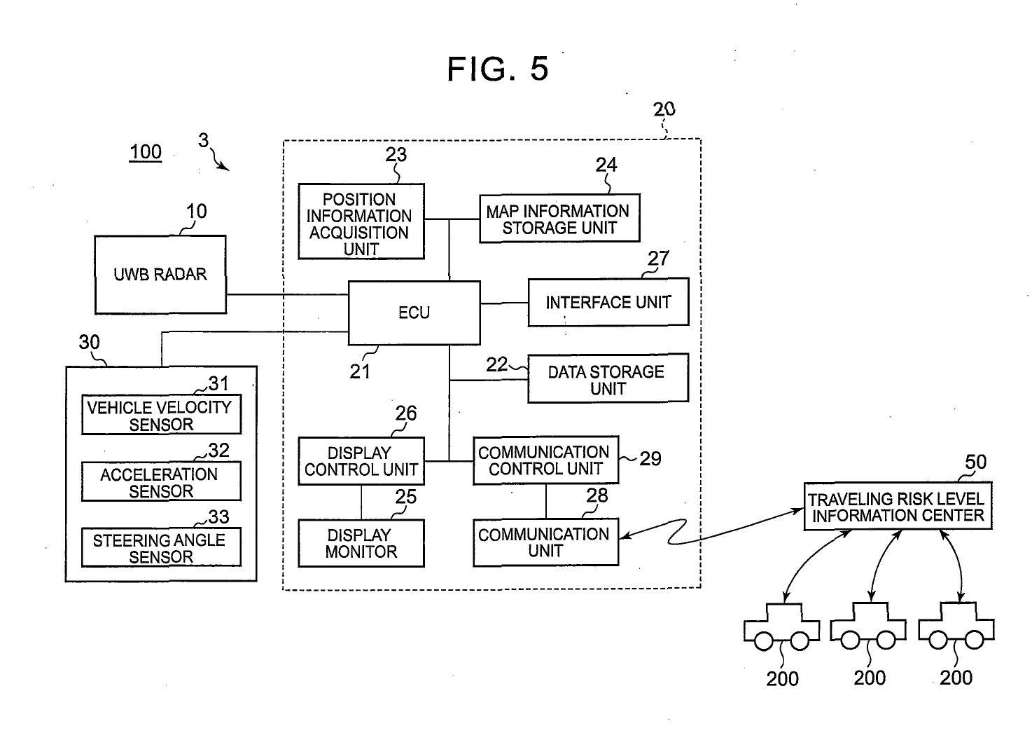

FIG. 5 is an overall schematic diagram illustrating a driving assistance apparatus 3 of the present embodiment.

The driving assistance apparatus 3 of the present embodiment is different from the first embodiment in that it can communicate with a traveling risk level information center 50 described below and acquire the traveling risk levels of each road section which have been transmitted from a plurality of probe vehicles 200 to the traveling risk level information center 50. Hereinafter, with like reference numerals attached to the same components as the first embodiment, mainly only different portions will be described.

Like the first embodiment, the driving assistance apparatus 3 is mounted on the vehicle 100 and determines the traveling risk level of each road section as an index concerning the degree of risk upon traveling in each road section and records the traveling risk level of each road section to perform the driving assistance for the driver. Further, based on the recorded traveling risk level of each road section, it performs display or the like for encouraging attention on the display monitor 25 to perform the driving assistance for the driver. Further, it communicates with the traveling risk level information center 50 described below to obtain and record the traveling risk levels of each road section which have been transmitted from a plurality of the probe vehicles 200 to the traveling risk level information center 50, and perform the driving assistance for the driver based on the traveling risk level of the given road section.

The driving assistance apparatus 3 includes the communication unit 28, a communication control unit 29 and the like.

The communication unit 28 is a communication means for acquiring information transmitted from the traveling risk level information center 50 described below. In the present embodiment, it is a device for communicating with outside through a radio network such as mobile phone network, for example, a mobile phone terminal which is connected to a DCM (data communication module) or the navigation unit 20 regardless of whether it is connected by wire or wirelessly. It communicates with the traveling risk level information center 50 through radio network, a base station and the like to receive information transmitted from the traveling risk level information center 50. It is possible to transmit information from the driving assistance apparatus 3 (ECU 21) to the traveling risk level information center 50 and in case where the vehicle 100 is a probe vehicle, information concerning the traveling risk level of each road section recorded in the data storage unit 22 is transmitted to the traveling risk level information center 50. As described below, a signal which requests for distribution of information concerning the traveling risk level of each road section is transmitted to the traveling risk level information center 50.

The communication control unit 29 perform processing for converting information received by the communication unit 28 to data which is available for the ECU 21 and the like. Further, the communication control unit 29 performs conversion to a signal for transmitting data from the communication unit 28 to outside and the like.

The traveling risk level information center 50 receives information concerning the traveling risk level of each road section recorded by the plural probe vehicles 200 during traveling to create a database and performs service of distributing the data in response to a request from a vehicle and the like. In the present embodiment, a signal which requests for distribution of information concerning the traveling risk level of each road section is transmitted from the ECU 21 to the traveling risk level information center 50 via the communication unit 28. In response thereto, the information concerning the traveling risk level of each road section is transmitted from the traveling risk level information center 50 to the vehicle 100 (communication unit 28). In the meantime, the request for distribution of the information to the traveling risk level information center 50 may be performed periodically or arbitrarily according to a driver's instruction or the like.

Like the present embodiment, the probe vehicle 200 has a means for determining and recording the traveling risk level of each road section corresponding to traveling. Further, it has a communication unit for transmitting the recorded traveling risk level of each road section to the traveling risk level information center 50. In the meantime, as a probe vehicle, the vehicle 100 also transmits the traveling risk level of each road section which is determined by the ECU 21 and recorded in the data storage unit 22 to the traveling risk level information center 50.

Here, like the first embodiment, the driving assistance apparatus 3 (ECU 21) of the present embodiment determines and records the traveling risk level of each road section. FIG. 2 is a flow chart for determination of the traveling risk level to be performed by the driving assistance apparatus 3 (ECU 21) of the present embodiment. Thus, because a specific method for determination and recording of the traveling risk level of each road section is the same as the first embodiment, a detailed description thereof is omitted.

Next, a recording method when the driving assistance apparatus 3 (ECU 21) of the present embodiment acquires the traveling risk level of each road section transmitted from the traveling risk level information center 50 by a large numbers of probe vehicles 200 will be described.

Like the traveling risk level of each road section which is determined by the ECU 21 described in detail in the first embodiment, the traveling risk level of each road section which has been transmitted from the traveling risk level information center 50 and acquired is recorded in the data storage unit 22.

Here, if the traveling risk level of a road section corresponding to the traveling risk level acquired from the traveling risk level information center 50 has been already recorded, an average value obtained by averaging the traveling risk level acquired from the traveling risk level information center 50 and the already recorded traveling risk level is recorded in the data storage unit 22 as a new traveling risk level of the given road section.

Next, an example of driving assistance using the traveling risk level of each road section recorded in the data storage unit 22 by means of the ECU 21 will be described. Because the traveling risk level of each road section for use here is the same as that described in the first embodiment except it includes the traveling risk levels acquired from the traveling risk level information center 50 and recorded as well as those determined and recorded by the ECU 21, a detailed description thereof is omitted.

Next, an operation of the driving assistance apparatus 3 of the present embodiment will be described. In the meantime, the present embodiment exerts the same operation and effect as the driving assistance apparatus 1 of the first embodiment and description of the same operation and effect is omitted.

In the present embodiment, the driving assistance apparatus 3 has a communication means for communicating with the traveling risk level information center 50 and the traveling risk level information center 50 receives information from the probe vehicle 200 to acquire the traveling risk levels of each road section which are formed into database. As a result, the traveling risk level of a road section in which the vehicle 100 has not traveled before is recorded in the data storage unit 22 so that it can be used for the driving assistance. Thus, the driver can avoid any risk securely even in a road section where the he or she has not traveled before.

Here, in the present embodiment, if the traveling risk level of a road section corresponding to the traveling risk level acquired from the traveling risk level information center 50 has been already recorded, an average value obtained by averaging the traveling risk level acquired from the traveling risk level information center 50 and the already recorded traveling risk level is recorded in the data storage unit 22 as a new traveling risk level of the given road section. As a result, accuracy of the traveling risk level of the given road section can be intensified more quickly so that the traveling risk level comes to correspond to an actual state of the road more accurately. Further, by performing driving assistance by reporting the traveling risk level to the driver using the traveling risk level which corresponds to the actual state of the road more accurately, the driver can avoid any risk more securely.

In the meantime, although the driving assistance apparatus 3 of the present embodiment is constructed by reforming the driving assistance apparatus 1 of the first embodiment so as to be able to acquire the traveling risk level of each road section from the traveling risk level information center 50, the same configuration may be applied to the driving assistance apparatus 2 of the second embodiment.

Although the embodiments for carrying out the present invention have been described in detail, the present invention is not restricted to such particular embodiments, but may be modified or altered in various ways within a range of the gist of the present invention described in claims of the invention.

Although in the above-described embodiments, the determination of the traveling risk level of each road section is performed by the ECU 21 in the navigation unit 20, it is permissible to provide the ECU separately from the navigation unit 20 to determine the traveling risk level of each road section. Further, although the traveling risk level of each road section is recorded in the data storage unit 22 in the navigation unit 20, it may be stored in a nonvolatile storage unit provided separately from the navigation unit 20.

Further, although, in the above-described embodiments, the motorbike, the bicycle and people are not discriminated depending on whether or not they are moving in the mapping shown in FIG. 3A for determining the traveling risk level due to the movable object, they may be discriminated like the vehicle. More specifically, the weight coefficient may be changed depending on whether they are moving or stationary. To increase accuracy further, the weight coefficient may be classified finely depending on the velocity of the movable object.

Although in the above-described embodiments, all data of any detected object input from the UWB radar 10 is processed along the flow chart shown in FIG. 2, processing of data which never affects the traveling risk level may be cancelled halfway. For example, referring to FIG. 3A, if a distance between the vehicle 100 and a movable object is 2.5 m or more, the weight coefficient is 0 thereby never affecting the traveling risk level. Thus, for any movable object 2.5 m or more apart from the vehicle 100, the processing may be cancelled halfway.

Although in the above-described embodiment, the total traveling risk level of each road section is determined and that traveling risk level is recorded, it is permissible to record the traveling risk level due to the movable object and the traveling risk level due to the estimated road width, which belong to preliminary step thereof, together. Further, as the traveling risk level of each road section, it is permissible to record the traveling risk level due to the movable object and the traveling risk level due to the estimated road width without determining the total traveling risk level. Likewise, to encourage the driver to pay attention, when displaying the traveling risk level of each road section on the display monitor 25, it is permissible to display the traveling risk level due to the movable object and the traveling risk level due to the estimated road width as well as the total traveling risk level or it is permissible to display only the traveling risk level due to the movable object and the traveling risk level due to the estimated road width.

Although in the above-described embodiments, the traveling risk level of each road section is specified through ranks, for example, the total point of a map for use in determining the traveling risk level due to the movable object may be used as the traveling risk level as it is.

Although in the above-described embodiments, a single traveling risk level is linked with each road section, a plurality of the traveling risk levels may be recorded for each road section to perform the driving assistance. For example, there are cases in which the situation of the road section may differ largely depending on the weather, a day of the week, time and the like. In such a case, it is permissible to record a plurality of the traveling risk levels for each road section depending on the weather, a day of the week, time and the like. More specifically, when determining the traveling risk level of each road section by means of the driving assistance apparatuses 1, 2, 3, for example, it may be recorded as a traveling risk level of a predetermined time period depending on the time when the vehicle 100 detects any object. Likewise, when displaying the traveling risk level of each road section on the display monitor 25 to encourage the driver to pay attention, for example, a traveling risk level of each road section corresponding to a time period may be displayed depending on the time when the vehicle 100 travels.

Further, although in the above-described embodiments, the traveling risk level for driving assistance for the driver is displayed on the display monitor 25 contained in the navigation unit 20, it may be displayed on another dedicated monitor or the like.

1-11. (canceled)

12. A driving assistance apparatus comprising:
a surrounding object detection device configured to detect objects in surroundings of a vehicle;
a detected object classification unit configured to classify the objects detected by the surrounding object detection device to predetermined types;
a traveling risk level determination unit configured to determine traveling risk levels of road sections as indices, each of the indices indicating a degree of risk upon traveling in a corresponding one of the road sections based on the predetermined types of the objects classified by the detected object classification unit;
a traveling risk level recording unit configured to record the traveling risk levels of the road sections determined by the traveling risk level determination unit; and
a road width calculation unit configured to calculate road widths of the road sections, wherein
each of the predetermined types is a movable object or a fixed object;
the road width calculation unit is configured to calculate each of the road widths based on an object of the objects that is detected when the vehicle travels in a corresponding one of the road sections and that is classified to the fixed object by the detected object classification unit; and
the traveling risk level determination unit is configured to determine each of the traveling risk levels of the road sections based on the road widths calculated by the road width calculation unit.

13. The driving assistance apparatus according to claim 12, wherein
the movable object is any one of a vehicle, a motorbike, a bicycle or people.

14. The driving assistance apparatus according to claim 12, wherein
the traveling risk level determination unit is configured to determine the traveling risk levels of the road sections based on at least one of a relative distance between the vehicle and each of the objects, and a relative velocity between the vehicle and each of the objects.

15. The driving assistance apparatus according to claim 12, wherein
when a traveling risk level of one of the road sections corresponding to one of the traveling risk levels determined by the traveling risk level determination unit has been already recorded, the traveling risk level recording unit is configured to record an average value obtained by averaging the determined one of the traveling risk levels and the already recorded traveling risk level as a new traveling risk level of the one of the road sections.

16. The driving assistance apparatus according to claim 12, further comprising:
a communication unit configured to communicate with a traveling risk level information center configured to collect the traveling risk levels of the road sections from a plurality of probe vehicles, wherein
the traveling risk level recording unit is configured to acquire the traveling risk levels of the road sections from the traveling risk level information center via the communication unit and to record the acquired traveling risk levels of the road sections.

17. The driving assistance apparatus according to claim 16, wherein
when a traveling risk level of one of the road sections corresponding to one of the traveling risk levels acquired from the traveling risk level information center has been already recorded, the traveling risk level recording unit is configured to record an average value obtained by averaging the acquired one of the traveling risk levels and the already recorded traveling risk level as a new traveling risk level of the one of the road sections.

18. The driving assistance apparatus according to claim 12, wherein
the detected object classification unit, the traveling risk level determination unit, the traveling risk level recording unit, and the road width calculation unit constitute an electronic control unit, and
the electronic control unit is configured to report, when the vehicle travels in one of the road sections, a traveling risk level of the one of the road sections recorded by the traveling risk level recording unit to a driver.

19. The driving assistance apparatus according to claim 18, further comprising:
a route guidance unit configured to perform route guidance for the driver from a departure point specified by the driver to a destination, wherein
the electronic control unit is configured to report, to the driver, each of the traveling risk levels recorded as a traveling risk level of a corresponding one of the road sections contained in a route through which the vehicle is to be guided by the route guidance unit.

20. A driving assistance method comprising:
detecting objects in surroundings of a vehicle;
classifying each of the detected objects to a movable object or a fixed object;
calculating a road width of a road section based on an object of the detected objects that is detected when the vehicle travels in the road section and that is classified to the fixed object;
determining a traveling risk level of the road section as an index indicating a degree of risk upon traveling in the road section based on the calculated road width; and
recording the determined traveling risk level of the road section.
